(19) United States
(12) Patent Application Publication
(10) Pub. No.: US 2007/0010906 A1
(43) Pub. Date: Jan. 11, 2007

(54) Apparatus and system for monitoring a substrate processing, program for monitoring the processing and storage medium storing same

(75) Inventor: Keisuke Abe, Nirasaki-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/453,826

(22) Filed: Jun. 16, 2006

Related U.S. Application Data
(60) Provisional application No. 60/705,444, filed on Aug. 5, 2005.

(30) Foreign Application Priority Data
Jul. 11, 2005 (JP) 2005-202165

(51) Int. Cl. G06F 19/00

(52) U.S. Cl. 700/121

(57) ABSTRACT

An apparatus for monitoring a state of a substrate processing in a substrate processing apparatus for processing the substrate is connected thereto through a network. The apparatus for monitoring the substrate processing includes an input unit for receiving at least a recipe set value, an upper limit and a lower limit inputted for each of a plurality of control items for defining the substrate processing, and a first PCA calculation unit for calculating, as a threshold value for detecting an abnormality of the substrate processing, a PCA output value based on at least the set value, the upper limit and the lower limit for each of the plurality of control items, received by the input unit.

### FIELD OF THE INVENTION

The present invention relates to an apparatus and a system for monitoring a substrate processing, a program for monitoring the processing and a storage medium for storing same; and, more particularly, to an apparatus and a system for monitoring a state of the substrate processing, a program for monitoring the processing and a storage medium for storing same.

### BACKGROUND OF THE INVENTION

In order to estimate an operational state of a substrate processing apparatus such as a semiconductor manufacturing apparatus, a statistical method such as PCA (Principal Component Analysis) or SPC (Statistical Process Control) based on various parameters in accordance with a processing system or a transfer system is used in some cases. That is, a PCA model (past trend that indicates an occurrence of an abnormality of the apparatus or a product such as a substrate, and the like, by a parameter indicating a certain value) is created based on a plurality of samples of the various parameters accumulated over a long period of time. By comparing a present state of the apparatus with the PCA model, a processing state or an operational state of the apparatus can be monitored and controlled.

In the PCA, by monitoring just one PCA output value (Q, T2) calculated from the plurality of parameters, it is possible to estimate the operational state of the apparatus, thereby reducing an operational burden of an administrator.

Patent Document 1: Japanese Patent Laid-open Application No. 2003-197609

However, in the PCA model created based on a plurality of samples of the various parameters accumulated over a long period of time, even in case that a variation of a parameter value is equivalent to a margin of error, the PCA output value (Q, T2) can fluctuate extremely in some cases. That is to say, because absolute values or units of the respective parameters are not commensurable with each other, a normalization of each parameter value is performed so that a comparison of the parameters can become simple. However, if the variation is greater than the standard deviation for a parameter that is very stable and has a very small standard deviation obtained during a model period (target period for creating the PCA model), the PCA output value can fluctuate substantially although the variation is small. Therefore, it can be difficult to estimate from the PCA output value whether a processing is an abnormal processing which may have an effect on a quality of the product (substrate) or damage the apparatus.

Further, the PCA output value (Q, T2) can be meaningful only statistically, and in case that a variation of each parameter is equivalent to a value of a corresponding specification of the apparatus, a variation ratio of the corresponding PCA output value (Q, T2) is not constant. Therefore, it is difficult to set a threshold value to estimate whether a processing is an abnormal processing from the PCA output value (Q, T2).

Further, because it is necessary to sample the parameter value over a long period of time to create the PCA model, a preparation operation becomes burdensome.

Further, from the viewpoint of a characteristic of the PCA model, a parameter having a variance of zero cannot be incorporated in the model. Therefore, in a normal state, e.g., a reflection wave power or the like, a parameter having a constant value (for example, always “0”) is excluded from the PCA model, and accordingly, an abnormality inspection cannot be performed by a variation of the parameter.

### SUMMARY OF THE INVENTION

It is, therefore, an object of the present invention to provide an apparatus and a system for monitoring a substrate processing, a program for monitoring the processing and a storage medium storing same, with which a quality control of a product manufactured by using a substrate processing apparatus can be properly performed based on a PCA model.

In accordance with an aspect of the present invention, there is provided an apparatus for monitoring a state of a substrate processing in a substrate processing apparatus for processing the substrate, connected thereto through a network, including: an input unit for receiving at least a set value, an upper limit and a lower limit inputted for each of a plurality of control items for defining the substrate processing; and a first PCA calculation unit for calculating, as a threshold value for detecting an abnormality of the substrate processing, a PCA output value based on at least the set value, the upper limit and the lower limit for each of the plurality of control items, received by the input unit.

Further, in accordance with another aspect of the present invention, there is provided a system for monitoring a substrate processing including the apparatus for monitoring the substrate processing, a computer executable program for monitoring the processing and performing functions of the apparatus, or a storage medium storing the program.

In accordance with the present invention, there are provided an apparatus and a system for monitoring a substrate processing, a program for monitoring the processing and a storage medium storing same, with which a quality control of a product manufactured by using a substrate processing apparatus can be properly performed based on a PCA model.

### BRIEF DESCRIPTION OF THE DRAWINGS

The above and other objects and features of the present invention will become apparent from the following description of a preferred embodiment given in conjunction with the accompanying drawings, in which:

FIG. 1 offers a view schematically showing an example of a configuration of a substrate processing apparatus in accordance with a preferred embodiment of the present invention;

FIG. 2 shows an example of a configuration of a system controller in accordance with the preferred embodiment of the present invention;

FIG. 3 shows an example of a hardware configuration of a server for monitoring a substrate processing in accordance with the preferred embodiment of the present invention;

FIG. 4 depicts a view showing an example of a functional configuration of the server for monitoring the substrate processing in accordance with the preferred embodiment of the present invention;

FIG. 5 presents a flow chart for explaining a process sequence of a PCA threshold value calculation process performed by the server for monitoring the substrate processing in accordance with the preferred embodiment of the present invention;

FIG. 6 offers a view showing an example of a part of a recipe;

FIG. 7 shows a view for conceptually showing an example of a sample used for a PCA threshold value calculation;

FIG. 8 shows an equation used for a normalization;

FIG. 9 depicts a flow chart for explaining a process sequence of a process for monitoring the substrate processing, performed by the server for monitoring the substrate processing in accordance with the preferred embodiment of the present invention;

FIG. 10 presents a view showing an example of actual measurement values of control items;

FIG. 11 offers a view showing a variation of a PCA output value Q for each control item value in accordance with the preferred embodiment of the present invention;

FIG. 12 shows a view schematically showing an example of a configuration of another substrate processing apparatus in accordance with the preferred embodiment of the present invention;

FIG. 13 is a cross sectional view of a second process unit;

FIG. 14 depicts a perspective view schematically showing a configuration of a second process ship;

FIG. 15 presents a view schematically showing a configuration of a unit driving dry air supply system of a second load-lock unit; and

FIG. 16 offers a view showing a configuration example of a system controller of the above mentioned another substrate processing apparatus.

### DETAILED DESCRIPTION OF THE PREFERRED EMBODIMENTS

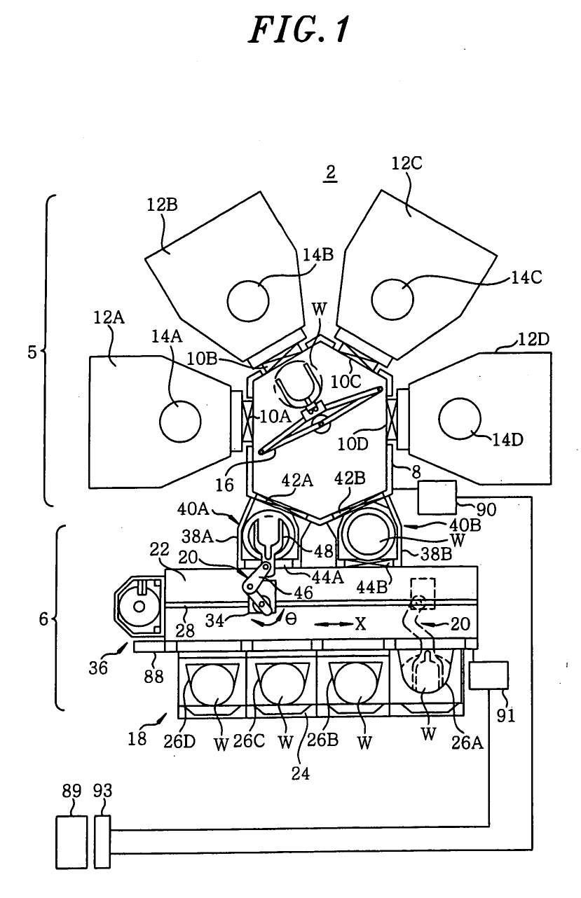

Hereinafter, a preferred embodiment of the present invention will be described with reference to the accompanying drawings. FIG. 1 schematically shows an example of a configuration of a substrate processing apparatus in accordance with a preferred embodiment of the present invention.

Referring to FIG. 1, a substrate processing apparatus 2 mainly includes a processing system 5 for performing various processes such as a film forming process, a diffusion process, an etching process or the like on a semiconductor wafer (substrate) W serving as a transfer target object, and a transfer system 6 for loading and unloading the wafer W into and out of the processing system. The processing system 5 includes a transfer chamber 8 which can be vacuum-exhausted, and four processing chambers 12A to 12D, connected thereto through respective gate valves 10A to 10D so that identical or different kind of heat treatment can be performed on the wafer W in each of the processing chambers 12A to 12D. In the processing chambers 12A to 12D, there are respectively provided susceptors 14A to 14D for mounting the wafer W. Further, an extensible, retractable and rotatable mounting and transferring arm unit 16 is provided in the transfer chamber 8 such that the wafer W can be transferred between the processing chambers 12A to 12D and load-lock chambers to be described later.

Meanwhile, the transfer system 6 includes a cassette stage 18 for mounting one or more cassette containers and a transfer stage 22 for moving a transfer arm unit 20 for transferring the wafer W. The cassette stage 18 is provided with a container mount 24 capable of mounting a plurality of cassette containers (up to four cassette containers 26A to 26D in the drawing) thereon. Each of the cassette containers 26A to 26D can accommodate a plurality of wafers W (e.g., up to 25 wafers), wherein the wafers are mounted therein with an equal pitch at multiple levels. On a central portion of the transfer stage 22, a guide rail 28 extending in a longitudinal direction thereof is provided to thereby support the transfer arm unit 20, wherein the transfer arm 20 is slidingly movable with respect to the guide rail 28.

Further, an orienter 36 serving as an orientation positioning device for performing a positioning of the wafer is provided on one end of the transfer stage 22, and two load-lock chambers 38A and 38B which can be vacuum-exhausted to connect the transfer stage 22 to the transfer chamber 8 are provided in the middle of the transfer stage 22. Target object mounts 40A and 40B for mounting the wafer W are provided in the respective load-lock chambers 38A and 38B, and gate valves 42A, 42B and 44A, 44B are provided at front and rear of the respective load-lock chambers 38A and 38B so that the load-lock chambers communicate with the transfer chamber 8 and the transfer stage 22 therethrough, respectively.

The substrate processing apparatus 2 further includes a system controller for controlling operations of the processing system 5, the transfer system 6 and the like, and an operation controller 88 disposed at one end of the transfer stage 22.

The operation controller 88 includes a display unit having, e.g., an LCD (Liquid Crystal display), which displays operational states of the substrate processing apparatus 2, log information to be described later, or the like.

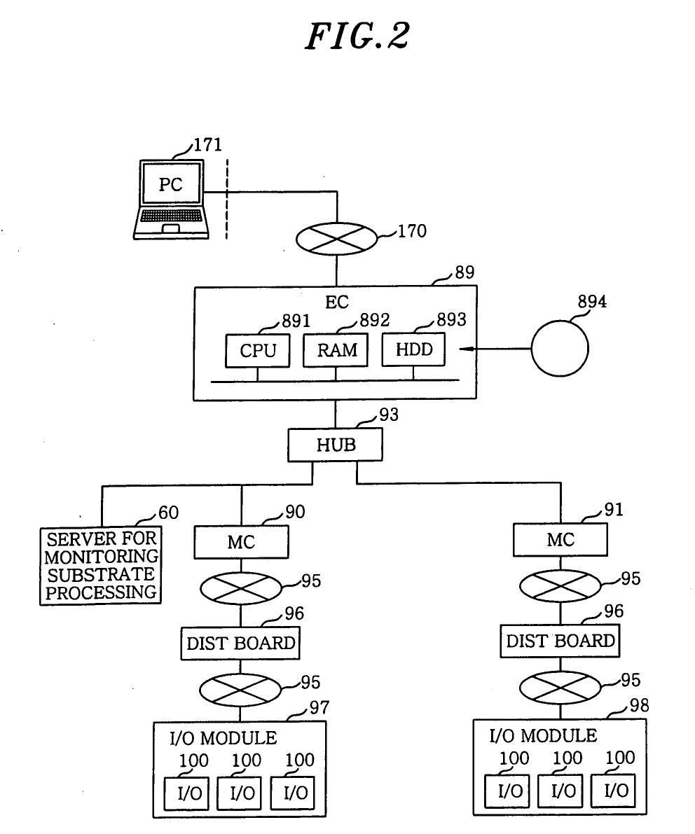

FIG. 2 is a view showing an example of a configuration of a system controller in accordance with the preferred embodiment of the present invention. Referring to FIG. 2, the system controller includes an EC (Equipment Controller) 89; two MC's (Module Controllers) 90 and 91; and a switching hub 93 for connecting the EC 89 to the respective MC's. The EC 89 of the system controller is connected through a LAN (Local Area Network) 170 to a PC 171 serving as a MES (Manufacturing Execution System) for managing manufacturing processes carried out in the whole factory in which the substrate processing apparatus 2 is installed. The MES in communication with the system controller feedbacks to a main operation system (not shown) real time information about the processes carried out in the factory and performs the judgments about the processes by considering a total load of the factory.

The EC 89 controlling the respective MC's is a main control unit (master control unit) for controlling operations of the entire substrate processing apparatus 2. Further, the EC 89 includes a CPU 891, a RAM 892, an HDD 893 or the like and controls operations of the processing system 5, the transfer system 6 and the like in such a manner that in accordance with a processing method of the wafer W, i.e., a program corresponding to a recipe, specified through the operation controller 88 by a user or the like, the CPU transmits a control signal to the respective MC's. Further, the EC 89 stores the log information based on information detected by various sensors (not shown) installed in the processing system 5 or transfer system 6 in the HDD 893.

The switching hub 93 selectively connects the EC 89 to the respective MC's in accordance with a control signal from the EC 89.

The MC's 90 and 91 are sub-control units (slave control units) for controlling the operations of the processing system 5 and the transfer system 6, respectively. The MC's are connected to respective I/O (Input/Output) modules 97 and 98, each through a GHOST network 95 by using a DIST (Distribution) board 96. The GHOST network 95 is implemented by an LSI called a GHOST (General High-Speed Optimum Scalable Transceiver) mounted on an MC board the MC has. Up to 31 I/O modules can be connected to the GHOST network 95, and in the GHOST network 95, the MC's are masters, and the I/O modules are slaves.

The I/O module 97 includes a plurality of I/O units 100 connected to each of constituent elements (hereinafter referred to as “end devices”) of the processing system 5, and transmits control signals to the respective end devices and output signals from the respective end devices. For example, an MFC (Mass Flow Controller) disposed on an ammonia gas supply line, an MFC disposed on a hydrogen fluoride gas supply line, a pressure gauge, an APC (Automatic Pressure Control) valve, an MFC disposed on a nitrogen gas supply line provided on each of the processing chambers 12A to 12D, and the mounting and transferring arm unit 16 in the transfer chamber 8 serve as the end devices connected to the I/O units 100 of the I/O module 97.

Further, a configuration of the I/O module 98 is identical to that of the I/O module 97, and a connective relationship thereof with the transfer system 6 is also identical to a connective relationship of the MC 90 and the I/O module 97, and hence the detailed explanation thereof will be omitted here for brevity.

Further, an I/O board (not shown) for controlling an input/output of digital, analog, and serial signals in the I/O units 100 is also connected to each GHOST network 95.

In the processing chamber 12A and the like of the substrate processing apparatus 2, a predetermined process is performed on the wafer W in such a manner that in accordance with a program corresponding to a recipe of the predetermined process, stored in the HDD 893, the CPU 891 of the EC 89 transmits a control signal to desired end devices through the switching hub 93, the MC 90, the GHOST network 95 and the I/O units 100 of the I/O module 97.

In the system controller shown in FIG. 2, a plurality of the end devices is not directly connected to the EC 89. Instead, the I/O units 100 connected to a plurality of the end devices are modularized to be included in the I/O module, and the each I/O module is connected to the EC 89 through each of the MC's and the switching hub 93 and, thus, a communication system can be simplified.

Further, because an address of the I/O unit 100 connected to a desired end device and an address of the I/O module including the I/O unit 100 are included in the control signals transmitted by the CPU 891 of the EC 89, the switching hub 93 and the MC's need not send a request to the CPU 891 about destinations of the control signals. Instead, the switching hub 93 refers to the address of the I/O module in the control signals and the GHOST of the MC's refers to the address of the I/O unit 100 in the control signals to thereby effectively transmit the control signals.

Referring to FIG. 2, a server for monitoring a substrate processing 60 is also connected to the hub 93 through the LAN. The server for monitoring the substrate processing 60 is a device for detecting an abnormal wafer W by monitoring a processing state of the wafer W in the substrate processing apparatus 2, and can be implemented by a general purpose computer, e.g., a PC (Personal Computer) or the like.

In accordance with the server for monitoring the substrate processing 60 of the preferred embodiment of the present invention, it employs a statistical dynamics by PCA to monitor the substrate processing. A process for monitoring the substrate processing performed by the server for monitoring the substrate processing 60 is mainly classified into a PCA output value (hereinafter referred to as a “PCA threshold value”) calculation process for distinguishing an abnormal state from a normal state and an abnormality detection process of the substrate processing performed based on the calculated PCA threshold value. The details of these processes will be described later.

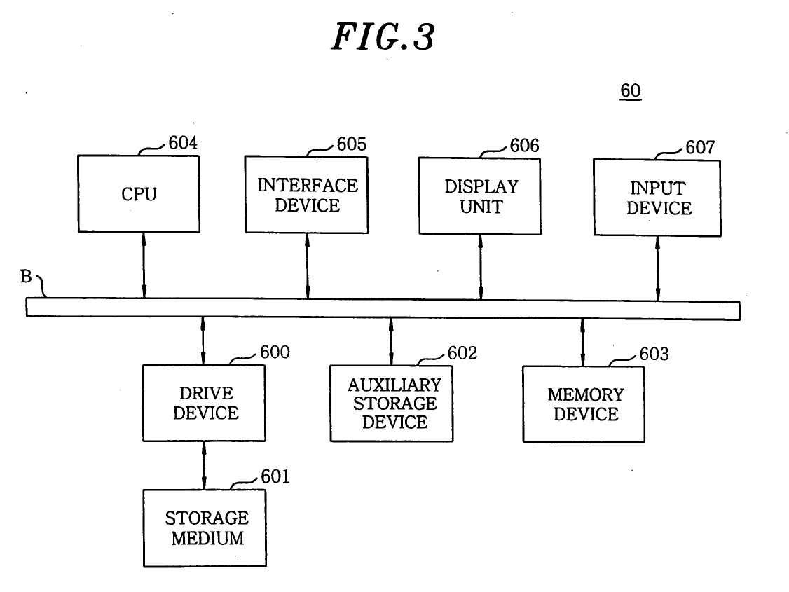

Hereinafter, the server for monitoring the substrate processing 60 will be described in detail. FIG. 3 is a view showing an example of a hardware configuration of the server for monitoring the substrate processing in accordance with the preferred embodiment of the present invention. In accordance with the present preferred embodiment, the server for monitoring the substrate processing 60 is configured to include a drive device 600, an auxiliary storage device 602, a memory device 603, a CPU 604, an interface device 605, a display unit 606, an input device 607 and the like, each being connected to each other via a bus B.

The program for implementing functions to be described later in the server for monitoring the substrate processing 60 is supplied by a storage medium 601, e.g., a floppy (registered trademark) disk, a hard disk, a magneto-optical disk, a CD-ROM, a CD-R, a CD-RW, a DVD-ROM, a DVD-RAM, a DVD-RW, a DVD+RW, a magnetic tape, a nonvolatile memory card, a ROM or the like. The storage medium 601 storing the program is set to be connected to the drive device 600, so that the program is installed from the storage medium 601 into the auxiliary storage device 602 via the drive device 600. Further, the program may be supplied by downloading not from the storage medium 601, but from a network.

The auxiliary storage device 602 stores the installed program as well as necessary files, data or the like. The memory device 603 reads out the program from the auxiliary storage device 602 when an instruction is given to start the program, and stores the read-out program. The CPU 604 performs the functions associated with the server for monitoring the substrate processing 60 in accordance with the program stored in the memory device 603. Herein, in the functions of the server for monitoring the substrate processing 60 performed by the CPU 604, functions that are based on processes of an OS (operating system) or the like of the server for monitoring the substrate processing 60 which is operated on the CPU 604 are included. Furthermore, the foregoing includes functions realized by a part or all of processes executed by a CPU in various function expansion boards or in a function expansion unit inserted into the server for monitoring the substrate processing 60 on the basis of the program in a memory after the program is written into the memory in the various function expansion boards or the function expansion unit.

Furthermore, the form of the program may be an object code, a program code executed by an interpreter, script data supplied to the OS, or the like.

The interface device 605 serves as an interface for connecting to a network (LAN). The display unit 606 displays a GUI or the like provided by a program. The input device 607 including a keyboard, a mouse or the like is used to input various operational instructions.

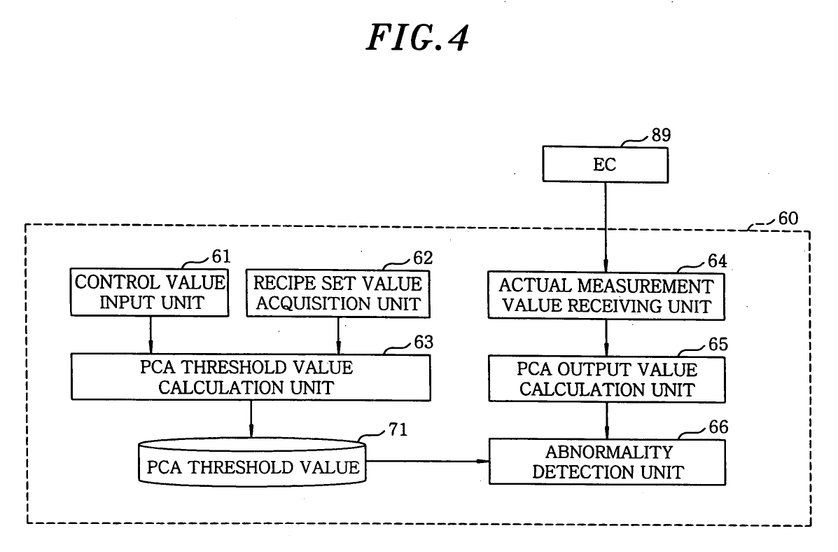

FIG. 4 is a view showing an example of a functional configuration of the server for monitoring the substrate processing in accordance with the preferred embodiment of the present invention.

Referring to FIG. 4, the server for monitoring the substrate processing 60 includes a control value input unit 61, a recipe set value acquisition unit 62, a PCA threshold value calculation unit 63, an actual measurement value receiving unit 64, a PCA output value calculation unit 65, an abnormality detection unit 66 and the like. These units are realized in such a manner that the program installed on the server for monitoring the substrate processing 60 is processed by the CPU 604. Further, the hub 93 is omitted from FIG. 4 for convenience.

The control value input unit 61, the recipe set value acquisition unit 62 and the PCA threshold value calculation unit 63 perform the PCA threshold value calculation process. Further, the actual measurement value receiving unit 64, the PCA output value calculation unit 65 and an abnormality detection unit 66 perform the abnormality detection process of the substrate processing. Further, functions of the respective units will be described in detail with reference to the accompanying flow chart.

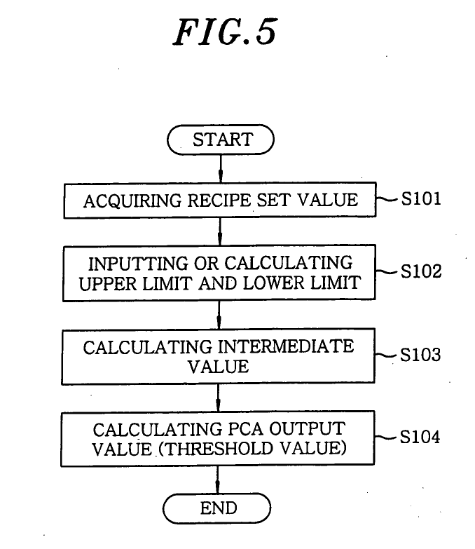

Hereinafter, a process sequence of the server for monitoring the substrate processing 60 will be described. FIG. 5 is a flow chart for explaining the process sequence of the PCA threshold value calculation process performed by the server for monitoring the substrate processing in accordance with the preferred embodiment of the present invention.

In steps S101 and S102, the control value input unit 61 receives a recipe set value, an upper limit and a lower limit inputted for each of a plurality of control items (parameters) for defining a process on the wafer W. That is, first of all, in step S101, the control value input unit 61 acquires set values for a plurality of control items for defining a process on the wafer W in each recipe stored in the HDD 893 of the EC 89 through the LAN.

Herein, the recipe includes processing information associated with the substrate processing in the processing chamber. To be more specific on this, the recipe is a process program associated with a process sequence for the processing chamber 12A or the like and the control items (target control values such as a temperature, a pressure, kinds of gases, gas flow rates, time and the like) and provided separately for each processing chamber to control a process on the wafer W.

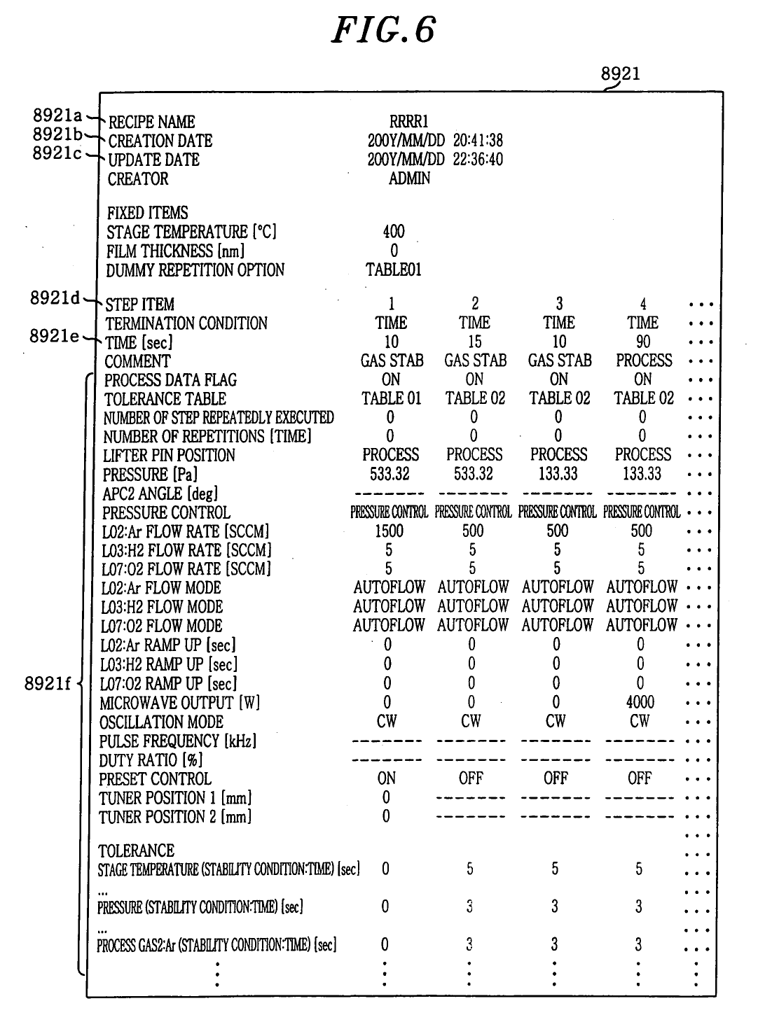

FIG. 6 shows an example of a part of a recipe. A recipe name 8921a for identifying each recipe, a creation date 8921b and an update date 8921c are recorded in a recipe 8921 shown in FIG. 6. It is necessary to record the items such as the creation date 8921b and the update date 8921c because a content of the recipe 8921 is updated.

A step item 8921d indicates step numbers of the respective steps included in the process sequence by the recipe 8921. Although four steps 1 to 4 are shown here, the number of the steps is actually more than that. Further, time 8921e indicates a needed time for each step. In a part indicated by a reference numeral 8921f thereafter, set values (hereinafter referred to as “recipe set values 8921f”) of various control items are described for each step. A process in the processing chamber 12A or the like is performed in such a manner that the CPU 891 of the EC 89 outputs the values of the control items in each step to the substrate processing apparatus 2 based on the recipe 8921.

That is, the recipe set values 8921f are acquired in step S101. However, the recipe set values 8921f may be extracted from the recipe 8921 in the server for monitoring the substrate processing 60 after the recipe 8921 stored as a file by an FTP (File Transfer Protocol) or the like is acquired as it is in the server for monitoring the substrate processing 60 by the control value input unit 61.

Further, in step S102, the upper limit and the lower limit of each control item of the recipe 8921 are inputted. Herein, the upper limit and the lower limit define a range within which a quality of the wafer W is guaranteed in the substrate processing of the substrate processing apparatus 2. That is, the upper limits are maximum values for guaranteeing the quality of the wafer W. Therefore, in case a value of a control item is more than a specific value so that the quality of the wafer W may be deteriorated, the specific value is the upper limit. Further, the lower limits are minimum values for guaranteeing the quality of the wafer W. Therefore, in case a value of a control item is lower than a specific value so that the quality of the wafer W may be deteriorated, the specific value is the lower limit.

Further, the upper limits and the lower limits may be set in accordance with a characteristic of the wafer W or a level of the quality to be guaranteed. Or, the upper limits and the lower limits may not be inputted by the user, but the control value input unit 61 may automatically calculate them based on the recipe set values. In both cases, it is preferable to set the upper limits and the lower limits within respective ranges of intrinsic values of a specification of the substrate processing apparatus 2 or limits called control threshold values, alarm threshold values or apparatus I/L (InterLock) values (in short, values within a tolerance range of acceptable performance of the substrate processing apparatus 2, hereinafter referred to as “control threshold values”).

For example, in case the control value input unit 61 automatically calculates the upper limits and the lower limits, they may be calculated by multiplying each control threshold value or recipe set value by a predetermined coefficient (ratio).

By proceeding from step S102 to step S103, the PCA threshold value calculation unit 63 calculates intermediate values of the upper limit and the recipe set value, and the lower limit and the recipe set value, respectively (S103). That is, the intermediate values 1 and 2 are calculated by performing an operation to be described hereinafter for each control item.

Intermediate value 1=(upper limit+recipe set value)/2

Intermediate value 2=(lower limit+recipe set value)/2

By proceeding from step S103 to step S104, the PCA threshold value calculation unit 63 performs a normalization (Scaling and centering) of the upper limit; the recipe set value, the lower limit, the intermediate value 1 and the intermediate value 2 of each control item to calculate a PCA output value Q by using thus normalized upper limit, recipe set value, lower limit, intermediate value 1 and intermediate value 2 as input information. The calculated value is stored in the auxiliary storage device 602 as a PCA threshold value 71. Further, the PCA threshold value 71 is not provided for each control item, but a value is calculated based on a sample of the plurality of control items.

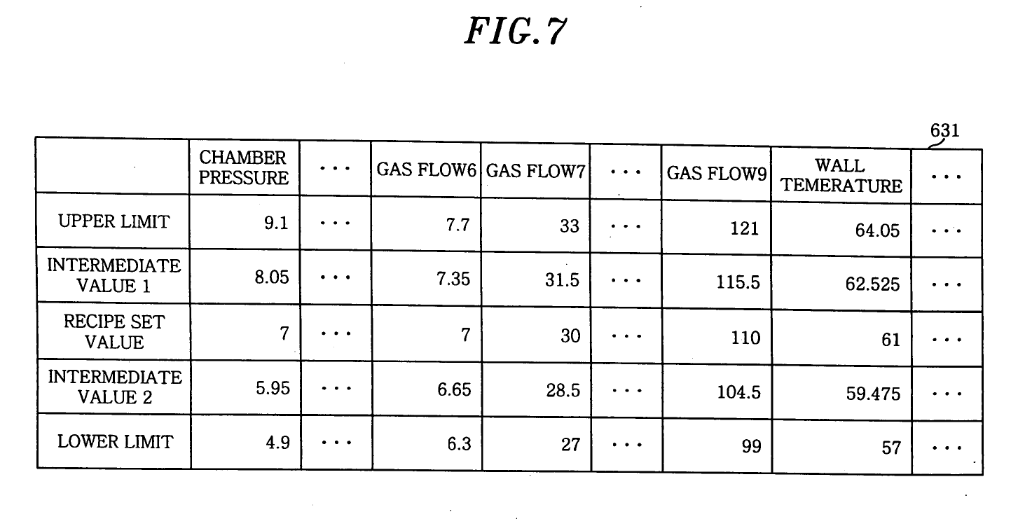

That is to say, in step S104, five values (upper limit, recipe set value, lower limit, intermediate value 1 and intermediate value 2) for each control item form a sample. FIG. 7 conceptually shows an example of the sample used for a PCA threshold value calculation.

In Table 631 shown in FIG. 7, each row represents data for each of the values (upper limit, intermediate value 1, recipe set value, intermediate value 2 and lower limit), and each column represents data for each of the control items so that the upper limit, the intermediate value 1, the recipe set value, the intermediate value 2 and the lower limit are shown for each control item. This information shown in Table 631 serves as input information for calculating the PCA threshold value 71. Further, each value in the drawing is for convenience. Further, the control items shown in FIG. 7 do not necessarily correspond with the control items shown in FIG. 6, but are illustrated for convenience.

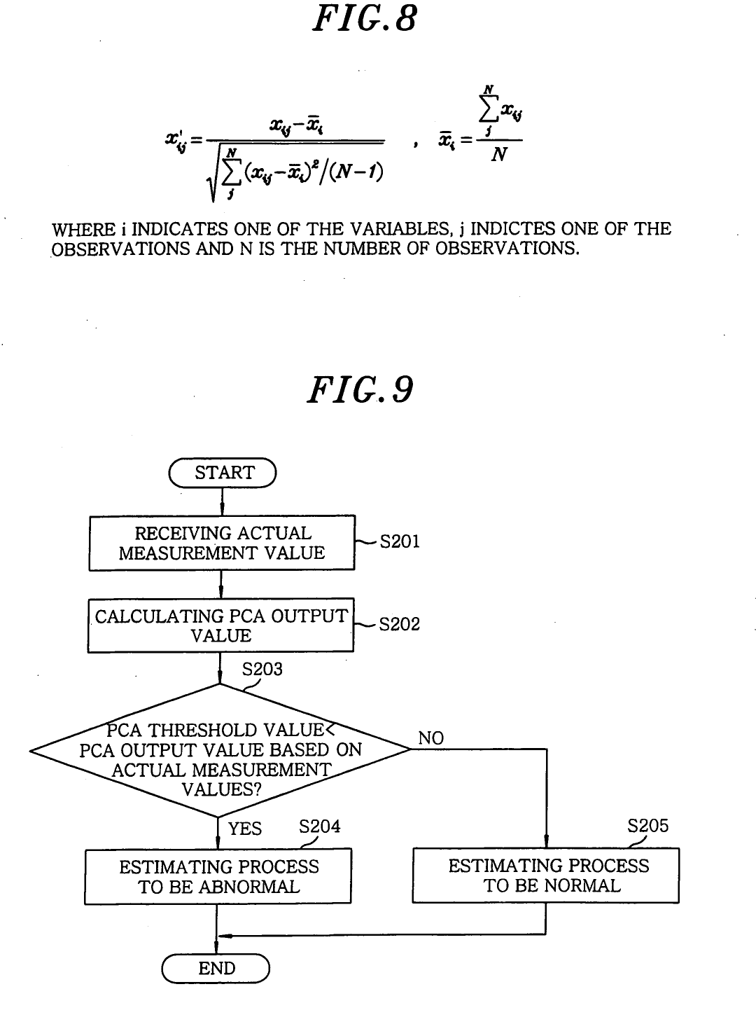

Meanwhile, the normalization is a mathematical process for correcting an inconsistency of absolute values and units of the respective control items, which is performed so that a comparison thereof becomes simple. By the normalization, the average values become 0, and the variances become 1. An equation of the normalization is shown in the drawing for reference. FIG. 8 is the equation used for the normalization. A calculation shown in FIG. 8 is performed for each control item.

As mentioned above, the PCA threshold value calculation process is completed. Hereinafter, the process for monitoring the substrate processing will be described. FIG. 9 is a flow chart for explaining a process sequence of the process for monitoring the substrate processing, performed by the server for monitoring the substrate processing in accordance with the preferred embodiment of the present invention. Herein, it is assumed that a process of the wafer W has been performed in advance by the substrate processing apparatus 2.

In step S201, the actual measurement value receiving unit 64 receives actual measurement values of the respective control items from the log information stored in the EC 89, i.e., values corresponding to the respective control items, sampled when the wafer W is actually processed in the processing chamber or the like of the substrate processing apparatus 2 via the LAN.

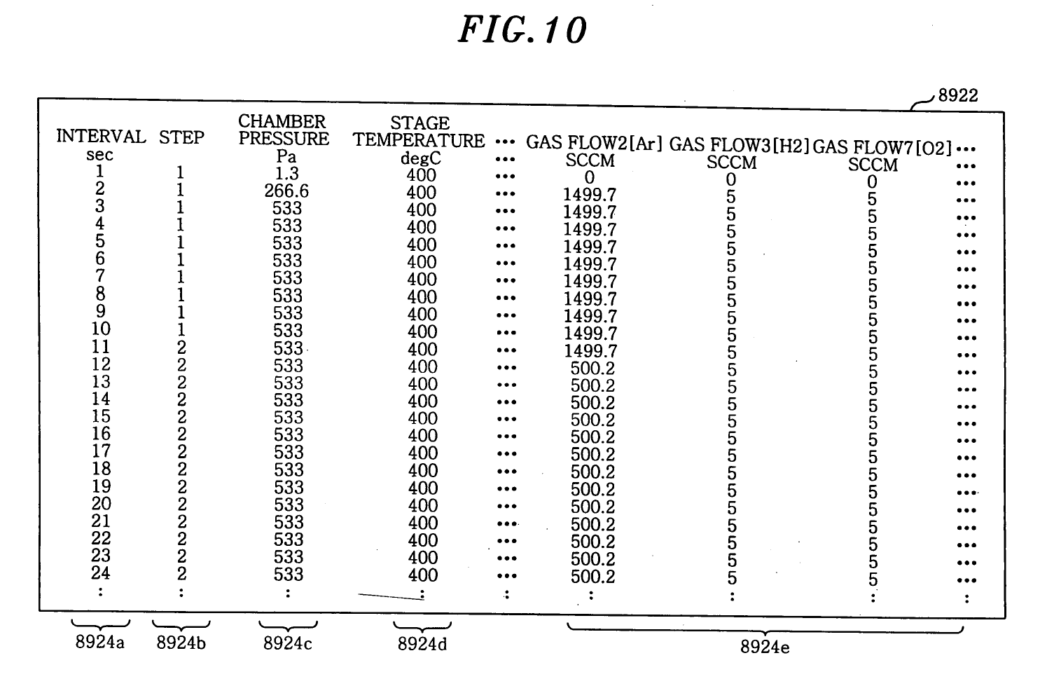

FIG. 10 shows an example of the actual measurement values of the control items. The actual measurement values 8922 shown in FIG. 10 are values based on a process of a wafer W in a processing chamber. Referring to FIG. 10, history data of each actual measurement value is shown at one-second intervals. That is, elapsed time is recorded in a column 8922a, and a step number of a step (step defined by the recipe 8921) executed at that time is recorded in a column 8922b. Further, measured values of a pressure, a temperature, gas flow rates and the like are recorded in columns 8922c, 8922d, 8922e and the like. Additional information is also recorded, but is omitted for convenience. Further, the control items shown in FIG. 10 do not necessarily correspond with the control items shown in FIG. 6 or 7, but are shown for convenience.

By proceeding from step S201 to step S202, the PCA output value calculation unit 65 calculates a PCA output value Q by using the actual measurement values 8922 as input information. Herein, a value is calculated as the PCA output value Q, based on the actual measurement values of the plurality of control items. Thus calculated PCA output value is hereinafter referred to as a “PCA output value based on the actual measurement values”.

By proceeding from step S202 to step S203, in such a manner that the abnormality detection unit 66 compares the PCA threshold value 71 with the PCA output value based on the actual measurement values, it estimates whether or not a processing is an abnormal processing which may have an effect on the quality of the wafer W (S203) in the substrate processing by the substrate processing apparatus 2.

That is to say, if the PCA output value based on the actual measurement values is greater than the PCA threshold value (Yes at S203), the abnormality detection unit 66 estimates that a processing is an abnormal processing (S204). On the other hand, if the PCA output value is not greater than the PCA threshold value (No at S203), the abnormality detection unit 66 estimates that a processing is a normal processing (S205). If the abnormality detection unit 66 detects an abnormality, it notifies the information on the abnormality to the user, for example, by displaying an alarm for notifying the abnormality on the display unit 606 or by sounding a buzzer.

As described above, in accordance with the server for monitoring the substrate processing 60 of the preferred embodiment of the present invention, because the PCA module is made from data including a difference between the upper limit and the lower limit of the each control item, the PCA output value (Q, T2) does not fluctuate extremely due to a variation within an error range less than that. Therefore, it becomes easy to estimate whether the substrate processing is normal or abnormal in the substrate processing apparatus 2. Therefore, quality control of a product (substrate) can be properly performed.

Further, because control values (upper limit and lower limit) determined by considering their influence on a processing result of the substrate processing in the substrate processing apparatus 2 are used as input information of a model, it is possible to have a connection between the PCA output value Q and the processing state of the substrate processing. Further, because sensitivity of the PCA output value for the abnormality of the value of each control item becomes equal by the normalization, it is possible to make a varying ratio of the Q value constant when a variation in the value of each control item is equal to the control threshold value. Therefore, a threshold value (PCA threshold value) can be determined for the PCA output value.

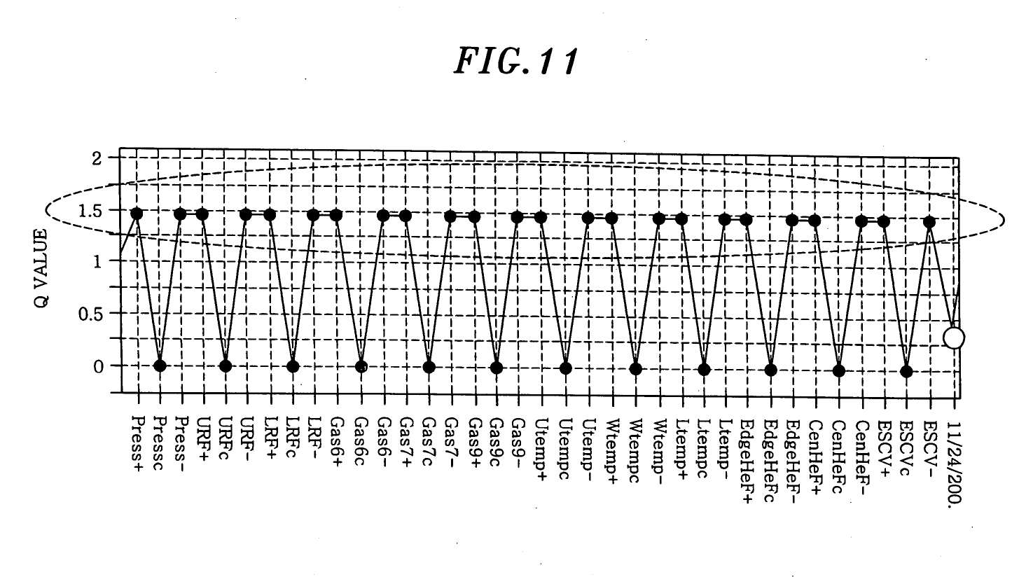

FIG. 11 shows a variation of a PCA output value Q for each control item value in accordance with the preferred embodiment of the present invention. Referring to a graph shown in FIG. 11, an upper limit, a recipe set value, a lower limit of each control item are shown along a horizontal axis, and the PCA output value Q is shown along a vertical axis. That is, Press+, PressC and Press− of the three from the left of the horizontal axis are an upper limit, a recipe set value and a lower limit of the pressure that is one of the control items, respectively. In the same manner, “+”, “C” or “−” is added for each control item to indicate the upper limit, the recipe set value or the lower limit. As shown in a portion enclosed by the dashed line in FIG. 11, in accordance with a PCA model creation method of the present preferred embodiment, based on the recipe set value, the upper limit, the lower limit and the like, it can be known that the PCA output value Q becomes the same whether each control item has the upper limit or the lower limit. Therefore, this value can be employed as the PCA threshold value.

Further, in a creation of a PCA model (PCA threshold value), because it is necessary to input the set value, the upper limit and the lower limit instead of the actual measurement values (empirical values) of each control item, it is not necessary to sample the data over a long period of time for the creation of the PCA model.

Further, in the creation of the PCA model, because the upper limit and the lower limit are inputted for each control item, the values of a certain control item do not become constant (variance does not become 0), and even values of a reflection wave or the like, which are almost constant, can also be incorporated in the model. Therefore, it becomes possible to detect the abnormality based on values of all control items. Further, as described above, although the intermediate values 1 and 2 are calculated as a sample for calculating the PCA threshold value, the intermediate values 1 and 2 are not necessarily needed in theory. Therefore, the PCA threshold value may be calculated based on the recipe set value, the upper limit and the lower limit.

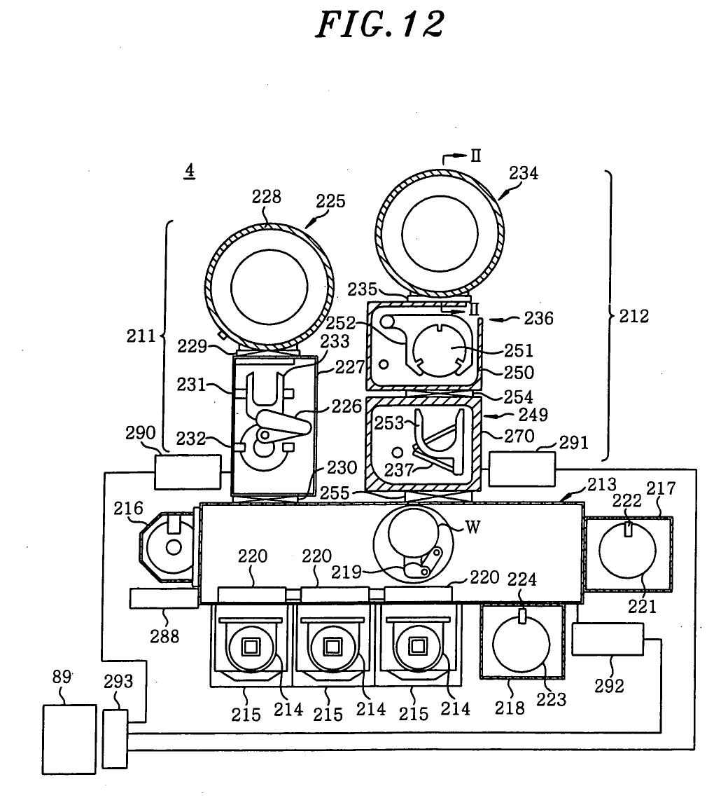

Meanwhile, the substrate processing apparatus 2 may be configured, for example, as shown in FIG. 12. FIG. 12 schematically shows an example of a configuration of another substrate processing apparatus in accordance with the preferred embodiment of the present invention.

Referring to FIG. 12, a substrate processing apparatus 4 includes a first process ship 211 for performing a reactive ion etching (hereinafter referred to as “RIE”) process on a wafer W; a second process ship 212 disposed in parallel with the first process ship 211, for performing a COR (Chemical Oxide Removal) process and a PHT (Post Heat Treatment) process on the wafer W after the RIE process is performed thereon in the first process ship 211; and a rectangular shaped loader unit 213 serving as a common transfer chamber, to which the first process ship 211 and the second process ship 212 are respectively connected.

To the loader unit 213, there are connected, in addition to the first process ship 211 and the second process ship 212, three FOUP platforms 215, each for mounting thereon a FOUP (Front Opening Unified Pod) 214 serving as a container accommodating 25 wafers W; an orienter 216 for performing the positioning of the wafer W unloaded from the FOUP 214; and a first and second IMS (Integrated Metrology System, Therma-Wave, Inc.) 217 and 218 for measuring a surface state of the wafer W.

The first process ship 211 and the second process ship 212 are connected to a sidewall in a longitudinal direction of the loader unit 213, and disposed to face the three FOUP platforms 215 across the loader unit 213; the orienter 216 is disposed on one end in the longitudinal direction of the loader unit 213; the first IMS 217 is disposed on the other end in the longitudinal direction of the loader unit 213; and the second IMS 218 is disposed in parallel with the three FOUP platforms 215.

The loader unit 213 includes a scalar dual-arm type transfer arm mechanism 219 disposed therein for transferring a wafer W; and three loading ports 220 serving as input ports of the wafers, disposed on the sidewall correspondingly to the respective FOUP platforms 215. The transfer arm mechanism 219 unloads the wafer W from one of the FOUP's 214 mounted on the corresponding FOUP platform 215 via the corresponding loading port 220, loads the unloaded wafer W into the first process ship 211, the second process ship 212, the orienter 216, the first IMS 217, or the second IMS 218, and unloads the wafer therefrom.

The first IMS 217 is a monitor of an optical system, and includes a stage 221 for mounting the loaded wafer W, and an optical sensor 222 which points to the wafer W mounted on the stage 221, and measures a surface shape of the wafer W, e.g., a film thickness of a surface layer or a CD (Critical Dimension) value of a wiring trench or a gate electrode. The second IMS 218 is also a monitor of an optical system. Further, in the same manner as the first IMS 217, the second IMS 218 also includes a stage 223 and an optical sensor 224, and measures the number of particles on the surface of the wafer W.

The first process ship 211 includes a first process unit 225 serving as a first vacuum processing chamber for performing the RIE process on the wafer W; and a first load-lock unit 227 having a first built-in transfer arm 226 of a link-shaped single pick type for transferring the wafer W to the first process unit 225.

The first process unit 225 includes a cylindrical processing chamber, and an upper electrode and a lower electrode disposed in the processing chamber, wherein the distance between the upper and the lower electrode is set to be proper to perform the RIE process on the wafer W. Further, the lower electrode has at the top thereof an ESC (electrostatic chuck) 228 for chucking thereon the wafer W by a Coulomb force or the like.

In the first process unit 225, a processing gas introduced into the chamber is converted into a plasma by an electric field generated between the upper electrode and the lower electrode, to produce ions and radicals, so that the RIE process is performed on the wafer W by the ions and the radicals.

Although an internal pressure of the loader unit 213 is maintained at the atmospheric pressure, an internal pressure of the first process unit 225 is maintained at a vacuum in the first process ship 211. On this account, the first load-lock unit 227 serves as a vacuum transfer antechamber whose internal pressure is controllable by providing a vacuum gate valve 229 at a connection portion with the first process unit 225, and an atmospheric gate valve 230 at a connection portion with the loader unit 213.

In the first load-lock unit 227, the first transfer arm 226 is installed at a substantially central portion, and a first buffer 231 is installed at a side of the first process unit 225 from the first transfer arm 226, and a second buffer 232 is installed at a side of the loader unit 213 from the first transfer arm 226. The first buffer 231 and the second buffer 232 are disposed on a path along which a supporting portion (pick) 233 for supporting the wafer W disposed at a leading end portion moves. Therefore, in the first process unit 225, it is possible to easily replace the wafer W on which the RIE process is completed with a wafer W to be processed by RIE in such a manner that the wafer W on which the RIE process is completed is temporarily moved above the path of the supporting portion 233 by the first buffer 231 and the second buffer 232.

The second process ship 212 includes a second process unit 234 serving as a second vacuum processing chamber for performing the COR process on the wafer W; a third process unit 236 serving as a third vacuum processing chamber for performing the PHT process on the wafer W, connected to the second process unit 234 via a vacuum gate valve 235; and a second load-lock unit 249 having a built-in second transfer arm 237 of a link-shaped single pick type for transferring the wafer W to the second process unit 234 or the third process unit 236.

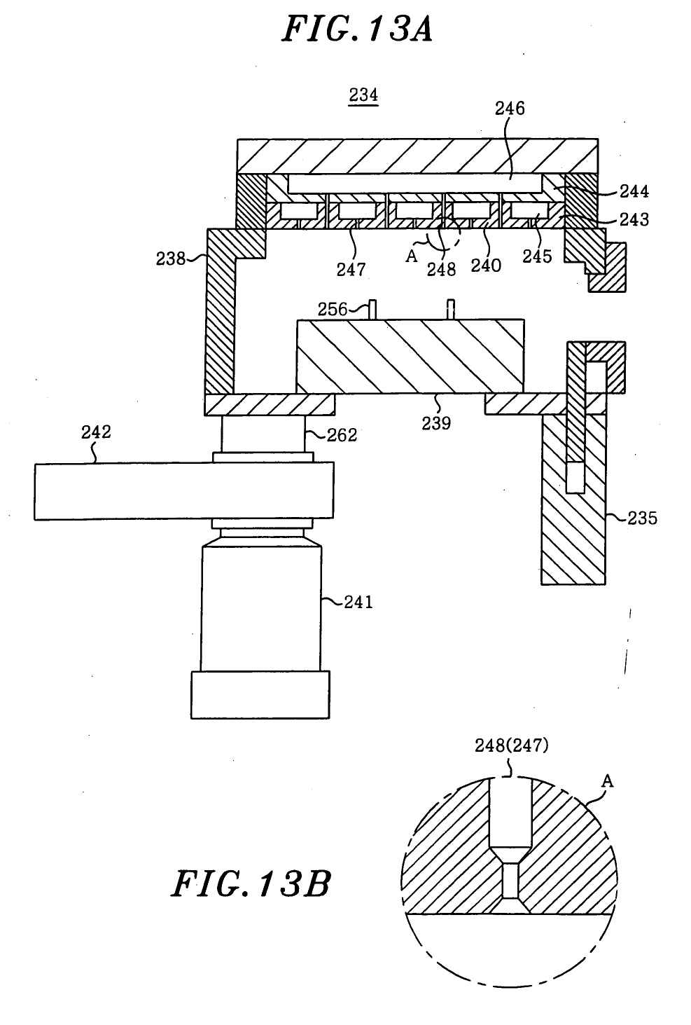

FIG. 13 is a cross sectional view of the second process unit, wherein FIG. 13A is a cross sectional view taken along the line II-II of FIG. 12, and FIG. 13B is an enlarged view of an A portion of FIG. 13A.

Referring to FIG. 13A, the second process unit 234 includes a cylindrical processing chamber 238; an ESC 239 serving as a stage for the wafer W and disposed in the processing chamber 238; a shower head 240 disposed at an upper portion of the processing chamber 238; a TMP (Turbo Molecular Pump) 241 for exhausting a gas or the like in the processing chamber 238; and an APC (Automatic Pressure Control) valve 242 which is a variable butterfly valve for controlling a pressure in the chamber 238, disposed between the processing chamber 238 and the TMP 241.

The ESC 239 has an electrode plate (not shown) embedded therein, into which a DC voltage is applied, and adsorptively holds the wafer W by the Coulomb force or a Johnsen-Rahbek force generated by the DC voltage. Further, the ESC 239 includes a plurality of pusher pins 256 acting as lift pins and protrusile from the top surface thereof, and the pusher pins 256 are received in the ESC 239 when the wafer W is adsorptively supported on the ESC 239. On the other hand, when the wafer W on which the COR process is completed is unloaded from the processing chamber 238, the pusher pins 256 are protruded from the top surface of the ESC 239. Accordingly, the wafer W is lifted up.

The shower head 240 having a two-layer structure has a first buffer chamber 245 and a second buffer chamber 246 at a lower portion 243 and an upper portion 244, respectively. The first buffer chamber 245 and the second buffer chamber 246 communicate with an inside of the processing chamber 238 through gas ventholes 247 and 248, respectively. When the COR process is performed on the wafer W, an NH₃ (ammonia) gas is supplied into the first buffer chamber 245 through an ammonia gas supply line 257 to be described later, and thus supplied ammonia gas is supplied into the processing chamber 238 through the gas ventholes 247. Simultaneously, an HF (hydrogen fluoride) gas is supplied to the second buffer chamber 246 through a hydrogen fluoride gas supply line 258 to be described later, and thus supplied hydrogen fluoride gas is supplied into the processing chamber 238 through the gas ventholes 248.

Further, as shown in FIG. 13B, respective openings of the gas ventholes 247 and 248 to the processing chamber 238 are formed in such a shape that an inner diameter of each opening becomes greater toward a bottom end thereof, so that the ammonia gas and the hydrogen fluoride gas can be efficiently diffused into the processing chamber 238. Further, because each of the gas ventholes 247 and 248 has a cross section including a narrowed neck portion, it can be prevented that deposits generated in the processing chamber 238 flow backward to the gas ventholes 247 and 248, or further to the first buffer chamber 245 or the second buffer chamber 246. Further, the gas ventholes 247 and 248 may be ventholes of a spiral shape.

The second process unit 234 performs the COR process on the wafer W by controlling the pressure in the chamber 238 and a volumetric flow rate ratio of the ammonia gas and the hydrogen fluoride gas.

Returning to FIG. 12, the third process unit 236 includes a processing chamber 250 of a housing shape; a stage heater 251 serving as a stage for the wafer W and disposed in the processing chamber 250; and a buffer arm 252 for lifting up the wafer W mounted on the stage heater 251 and disposed around the stage heater 251.

The stage heater 251 is made of aluminum having an oxide film of Y203 or the like formed thereon, and heats the mounted wafer W to a predetermined temperature by using a built-in heating wire or the like. In the second process unit 234 or the third process unit 236, it is possible to easily replace the wafer W in such a manner that the wafer W on which the COR process is completed is temporarily moved above the path of the supporting portion 253 of the second transfer arm 237 by the buffer arm 252.

The third process unit 236 performs the PHT process on the wafer W by controlling a temperature of the wafer W.

The second load-lock unit 249 includes a transfer chamber 270 of a housing shape, having the built-in second transfer arm 237. Further, although the internal pressure of the loader unit 213 is maintained at the atmospheric pressure, both of internal pressures of the second process unit 234 and the third process unit 236 are maintained at a vacuum. On this account, the second load-lock unit 249 serves as a vacuum transfer antechamber whose internal pressure is controllable by providing a vacuum gate valve 254 at a connection portion with the third process unit 236, and an atmospheric door valve 255 at the connection portion with the loader unit 213.

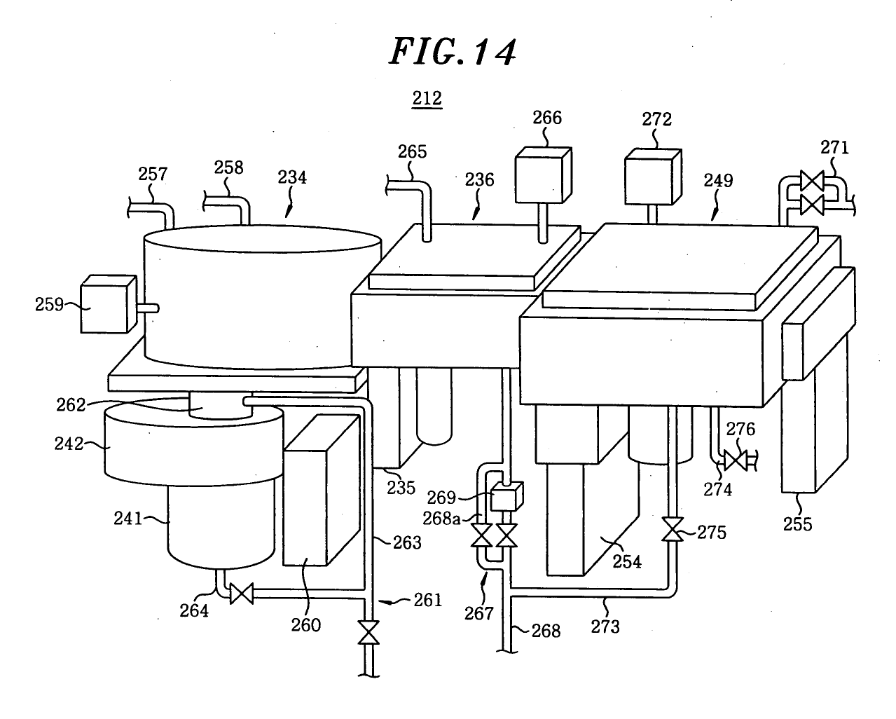

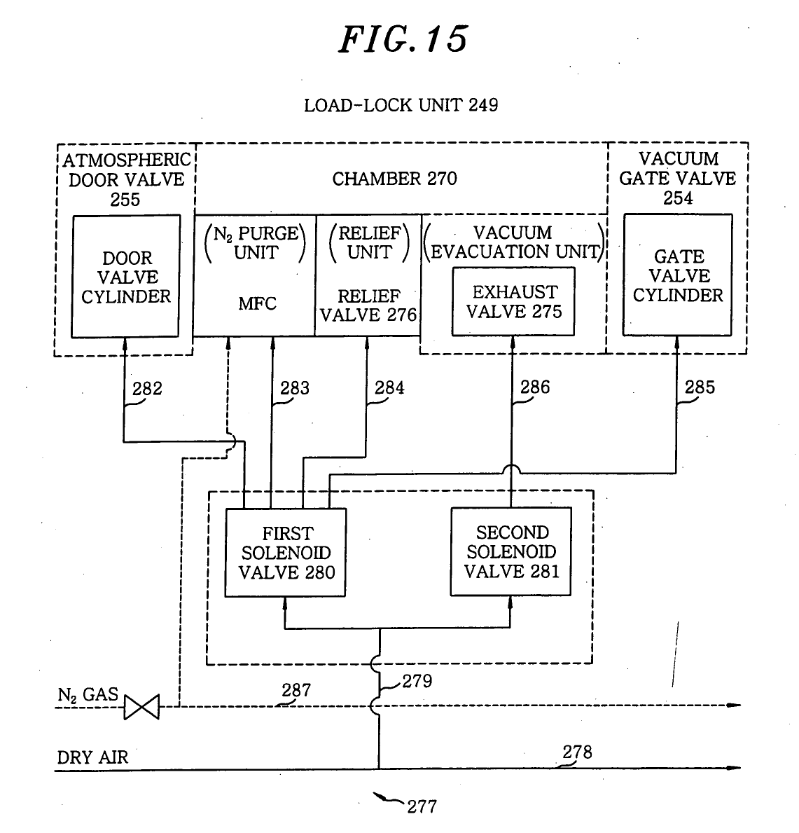

FIG. 14 is a perspective view schematically showing a configuration of the second process ship.

Referring to FIG. 14, the second process unit 234 includes the ammonia gas supply line 257 for supplying the ammonia gas into the first buffer chamber 245; the hydrogen fluoride gas supply line 258 for supplying the hydrogen fluoride gas into the second buffer chamber 246; a pressure gauge 259 for measuring the pressure in the processing chamber 238; and a chiller unit 260 for supplying a coolant to a coolant system disposed in the ESC 239.

An MFC (Mass Flow Controller) (not shown) is provided on the ammonia gas supply line 257, and the MFC controls a flow rate of the ammonia gas supplied to the first buffer chamber 245. An MFC (not shown) is also provided on the hydrogen fluoride gas supply line 258, and the MFC controls a flow rate of the hydrogen fluoride gas supplied to the second buffer chamber 246. The MFC of the ammonia gas supply line 257 and the MFC of the hydrogen fluoride gas supply line 258 cooperate to control the volumetric flow rate ratio of the ammonia gas and the hydrogen fluoride gas supplied to the processing chamber 238.

Further, a second process unit pumping system 261 connected to a DP (Dry Pump) (not shown) is disposed under the second process unit 234. The second process unit pumping system 261 includes a gas exhaust line 263 communicating with an exhaust duct 262 disposed between the processing chamber 238 and the APC valve 242; and a gas exhaust line 264 connected to an underside (exhaust side) of the TMP 241, and exhausts a gas or the like in the processing chamber 238. Further, the gas exhaust line 264 is connected to the gas exhaust line 263 just before the DP.

The third process unit 236 includes a nitrogen gas supply line 265 for supplying a nitrogen (N₂) gas into the processing chamber 250; a pressure gauge 266 for measuring the pressure in the processing chamber 250; and a third process unit pumping system 267 for exhausting the nitrogen gas or the like in the processing chamber 250.

An MFC (not shown) is provided on the nitrogen gas supply line 265, and the MFC controls a flow rate of the nitrogen gas supplied to the processing chamber 250. The third process unit pumping system 267 communicates with the processing chamber 250, and includes a main exhaust line 268 communicating with the processing chamber 250 and connected to a DP; an APC valve 269 disposed in the middle of the main exhaust line 268; and a sub-exhaust line 268a branched off from the main exhaust line 268 to bypass the APC valve 269 and connected to the main exhaust line 268 just before the DP. The APC valve 269 controls the pressure in the processing chamber 250.

The second load-lock unit 249 includes a nitrogen gas supply line 271 for supplying the nitrogen gas into the transfer chamber 270; a pressure gauge 272 for measuring a pressure in the transfer chamber 270; and a second load-lock unit pumping system 273 for exhausting the nitrogen gas or the like in the transfer chamber 270; and an atmosphere communicating pipe 274 for opening an inside of the transfer chamber 270 to atmosphere.

An MFC (not shown) is provided on the nitrogen gas supply line 271, and the MFC controls a flow rate of the nitrogen gas supplied to the transfer chamber 270. The second load-lock unit pumping system 273 includes one gas exhaust line, communicates with the transfer chamber 270, and is connected to the main exhaust line 268 of the third process unit pumping system 267 just before the DP. Further, the second load-lock unit pumping system 273 and the atmosphere communicating pipe 274 include an exhaust valve 275 and a relief valve 276, respectively. The exhaust valve 275 and the relief valve 276 cooperate to control the pressure in the transfer chamber 270 to a pressure in the range between an atmospheric pressure and a desired vacuum level.

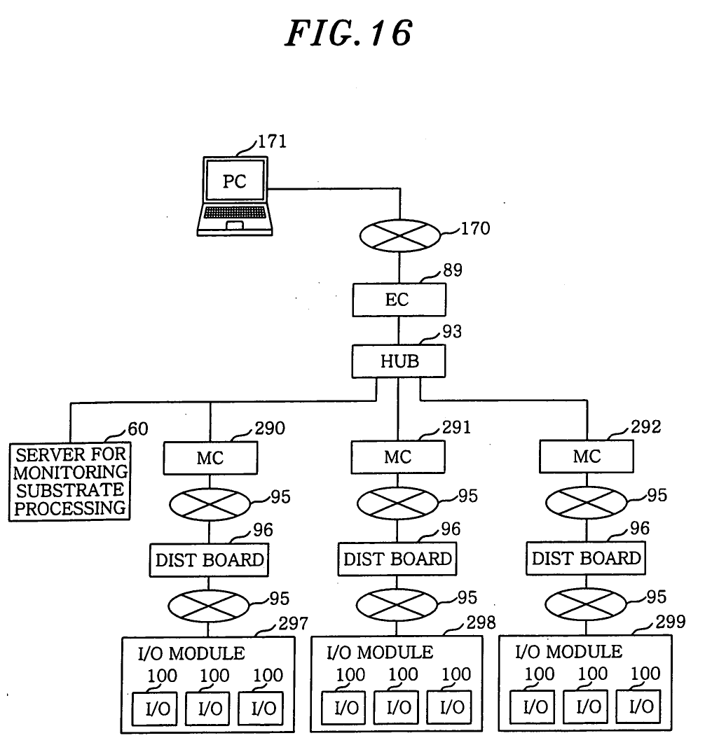

FIG. 15 schematically shows a configuration of a unit driving dry air supply system of the second load-lock unit.

Referring to FIG. 15, a door valve cylinder for driving a slide door included in the atmospheric door valve 255; the MFC included in the nitrogen gas supply line 271 serving as an N2 purge unit; the relief valve 276 included in the atmosphere communicating pipe 274 serving as a relief unit for opening to atmosphere; the exhaust valve 275 included in the second load-lock unit pumping system 273 serving as a vacuum evacuation unit; and a gate valve cylinder for driving a slide gate included in the vacuum gate valve 254, serve as a dry air supply source of the unit driving dry air supply system 277 of the second load-lock unit 249.

The unit driving dry air supply system 277 includes a sub-dry air supply line 279 branched off from a main dry air supply line 278 included in the second process ship 212; and a first solenoid valve 280 and a second solenoid valve 281 connected to the sub-dry air supply line 279.

The first solenoid valve 280 is connected to the door valve cylinder, the MFC, the relief valve 276 and the gate valve cylinder via dry air supply lines 282 to 285, respectively to control operations of the respective units by controlling an amount of dry air supplied thereto. Further, the second solenoid valve 281 is connected to the exhaust valve 275 via a dry air supply line 286 to control an operation of the exhaust valve 275 by controlling an amount of dry air supplied to the exhaust valve 275.

Further, the MFC of the nitrogen gas supply line 271 is also connected to a nitrogen (N₂) gas supply system 287.

Further, each of the second process unit 234 and the third process unit 236 also includes a unit driving dry air supply system having the same configuration as the unit driving dry air supply system 277 of the above-described second load-lock unit 249.

Returning to FIG. 12, the substrate processing apparatus 4 further includes a system controller for controlling operations of the first process ship 211, the second process ship and the loader unit 213; and an operation controller 288 disposed on one end in the longitudinal direction of the loader unit 213.

In the same manner as the operation controller shown in FIG. 1, the operation controller 288 includes a display unit having, e.g., the LCD (Liquid Crystal display), and the display unit displays operational states of the respective constituent element of the substrate processing apparatus 4, log information, or the like.

FIG. 16 shows a configuration example of the system controller of the above mentioned another substrate processing apparatus. In FIG. 16, like parts similar to those of FIG. 2 are designated by the like reference numerals and description thereof is omitted.

In FIG. 16, the MC's 290 to 292 are sub-control units (slave control units) for controlling the operations of the first process ship 211, the second process ship 212 and the loader unit 213, respectively. Each of the MC's is connected to a corresponding I/O (Input/Output) module 297, 298 or 299 through the GHOST network 95 by using the DIST (Distribution) board 96 in the same manner as in FIG. 2.

Further, a configuration of each of the I/O modules 297 to 299 is identical to that of the I/O module 97 or 98 shown in FIG. 2, except that they correspond to the first process ship. 211, the second process ship 212, and the loader unit 213, respectively.

A PCA threshold value calculation process, or an abnormality detection process of a substrate processing based on the PCA threshold value, each performed by the server for monitoring a substrate processing 60 shown in FIG. 16, can also be carried out by the same process sequence as that performed by the server for monitoring a substrate processing 60 shown in FIG. 2. Therefore, in the substrate processing of the substrate processing apparatus 4 shown in FIG. 12, the server for monitoring a substrate processing 60 shown in FIG. 16 can also calculate the PCA threshold value based on the recipe set value, the upper limit and the lower limit of each control item, so that an abnormal process of the substrate processing can be detected based on the calculated PCA threshold value.

While the invention has been shown and described with respect to the preferred embodiment, it will be understood by those skilled in the art that various changes and modifications may be made without departing from the scope of the invention as defined in the following claims.

What is claimed is:

1. An apparatus for monitoring a state of a substrate processing in a substrate processing apparatus for processing the substrate, connected thereto through a network, comprising:
an input unit for receiving at least a set value, an upper limit and a lower limit inputted for each of a plurality of control items for defining the substrate processing; and
a first PCA calculation unit for calculating, as a threshold value for detecting an abnormality of the substrate processing, a PCA output value based on at least the set value, the upper limit and the lower limit for each of the plurality of control items, received by the input unit.

2. The apparatus for monitoring the substrate processing of claim 1, further comprising:
an actual measurement value receiving unit for receiving actual measurement values of the plurality of control items, based on the substrate processing, from the substrate processing apparatus through the network;
a second PCA calculation unit for calculating a PCA output value based on the actual measurement values of the plurality of control items; and
a process abnormality detection unit for detecting the abnormality of the substrate processing by comparing the PCA output value serving as the threshold value with the PCA output value based on the actual measurement values.

3. The apparatus for monitoring the substrate processing of claim 2, wherein the process abnormality detection unit estimates that the substrate processing is abnormal in case the PCA output value based on the actual measurement values is greater than the PCA output value serving as the threshold value.

4. The apparatus for monitoring the substrate processing of claim 1, wherein the first PCA calculation unit calculates a PCA output value based on the set value, the upper limit, the lower limit, a first intermediate value of the set value and the upper limit, and the second intermediate value of the set value and the lower limit.

5. The apparatus for monitoring the substrate processing of claim 1, wherein the input unit calculates the upper limit and the lower limit based on the set value or a control threshold value of the substrate processing apparatus.

6. A system for monitoring a substrate processing comprising:
a substrate processing apparatus for processing a substrate; and
an apparatus for monitoring a state of the substrate processing in the substrate processing apparatus through a network, wherein
the apparatus for monitoring the substrate processing includes:
an input unit for receiving at least a set value, an upper limit and a lower limit inputted for each of a plurality of control items for defining the substrate processing; and
a first PCA calculation unit for calculating, as a threshold value for detecting an abnormality of the substrate processing, a PCA output value based on at least the set value, the upper limit and the lower limit for each of the plurality of control items, received by the input unit.

7. A program for monitoring, on a computer, a state of a substrate processing in a substrate processing apparatus connected thereto through a network, comprising:
an input module for receiving at least a set value, an upper limit and a lower limit inputted for each of a plurality of control items for defining the substrate processing; and
a first PCA calculation module for calculating, as a threshold value for detecting an abnormality of the substrate processing, a PCA output value based on at least the set value, the upper limit and the lower limit for each of the plurality of control items, received by the input unit.

8. The program for monitoring the substrate processing of claim 7, further comprising:
an actual measurement value receiving module for receiving actual measurement values of the plurality of control items, based on the substrate processing, from the substrate processing apparatus through the network;
a second PCA calculation module for calculating a PCA output value based on the actual measurement values of the plurality of control items; and
a process abnormality detection module for detecting the abnormality of the substrate processing by comparing the PCA output value serving as the threshold value with the PCA output value based on the actual measurement values.

9. The program for monitoring the substrate processing of claim 8, wherein the process abnormality detection module estimates that the substrate processing is abnormal in case the PCA output value based on the actual measurement values is greater than the PCA output value serving as the threshold value.

10. The program for monitoring the substrate processing of claim 7, wherein the first PCA calculation module calculates a PCA output value based on the set value, the upper limit, the lower limit, a first intermediate value of the set value and the upper limit, and the second intermediate value of the set value and the lower limit.

11. The program for monitoring the substrate processing of claim 7, wherein the input module calculates the upper limit and the lower limit based on the set value or a control threshold value of the substrate processing apparatus.

12. A computer readable storage medium storing the program for monitoring the substrate processing of claim 7.
